(19) United States
(12) Patent Application Publication
(10) Pub. No.: US 2024/0424858 A1
(43) Pub. Date: Dec. 26, 2024

(54) Climate Controlled Equine Trailer Device

(71) Applicant: Katherine LaRose, Columbia, TN (US)

(72) Inventor: Katherine LaRose, Columbia, TN (US)

(21) Appl. No.: 18/211,632

(22) Filed: Jun. 20, 2023

(51) Int. Cl. B60H 1/00; A01K 1/00; B60J 1/14; B60P 1/43; B60P 3/04; B60Q 3/30; B60R 16/033; B62D 63/08

(52) U.S. Cl. CPC B60H 1/00364; B60J 1/14; B60P 1/435; B60P 3/04; B60Q 3/30; B60R 16/033

(57) ABSTRACT

A climate controlled equine trailer device for maintaining an internal temperature of a gooseneck trailer at a comfortable temperature includes a gooseneck trailer and a plurality of air conditioning units. Each of the air conditioning units is attached to the gooseneck trailer to inhibit the horses inside of the gooseneck trailer from is exposed to dangerously high temperatures. A plurality of solar panels is attached to the gooseneck trailer for supplying electrical power to the plurality of air conditioning units. A plurality of light emitters is positioned in the gooseneck trailer to emit light into an interior of the gooseneck trailer. A light switch is positioned within the gooseneck trailer for turning the plurality of light emitters on and off.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to equine trailer devices and more particularly pertains to a new equine trailer device for maintaining an internal temperature of a gooseneck trailer at a comfortable temperature. The device includes a gooseneck trailer, a plurality of air conditioning units and a plurality of solar panels for powering the plurality of air conditioning units. Furthermore, the device includes a transceiver in wireless communication with a personal electronic device for remotely controlling the plurality of air conditioning units.

### (2) Description of Related Art Including Information Disclosed Under 37 CFR 1.97 and 1.98

The prior art relates to equine trailer devices including an animal trailer that has air exchange system for ventilating an interior of the animal trailer and a variety of livestock trailers that has various structural elements for enhancing comfort of livestock and a hybrid vehicle which employs solar cells for enhancing efficiency of the hybrid vehicle. In no instance does the prior art disclose an equine trailer with a plurality of air conditioning units, plurality of solar panels for powering the air conditioning units and a transceiver to facilitate a personal electronic device for remotely controlling the air conditioning units.

### BRIEF SUMMARY OF THE INVENTION

An embodiment of the disclosure meets the needs presented above by generally comprising a gooseneck trailer and a plurality of air conditioning units. Each of the air conditioning units is attached to the gooseneck trailer to inhibit the horses inside of the gooseneck trailer from is exposed to dangerously high temperatures. A plurality of solar panels is attached to the gooseneck trailer for supplying electrical power to the plurality of air conditioning units. A plurality of light emitters is positioned in the gooseneck trailer to emit light into an interior of the gooseneck trailer. A light switch is positioned within the gooseneck trailer for turning the plurality of light emitters on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a climate controlled equine trailer device according to an embodiment of the disclosure.

FIG. 2 is a front view of an embodiment of the disclosure.

FIG. 3 is a back view of an embodiment of the disclosure.

FIG. 4 is a top view of an embodiment of the disclosure.

FIG. 5 is a right side view of an embodiment of the disclosure.

FIG. 6 is a cross sectional view taken along line 6-6 of FIG. 2 of an embodiment of the disclosure.

FIG. 7 is a perspective in-use view of an embodiment of the disclosure.

FIG. 8 is a schematic view of an embodiment of the disclosure.

### DETAILED DESCRIPTION OF THE INVENTION

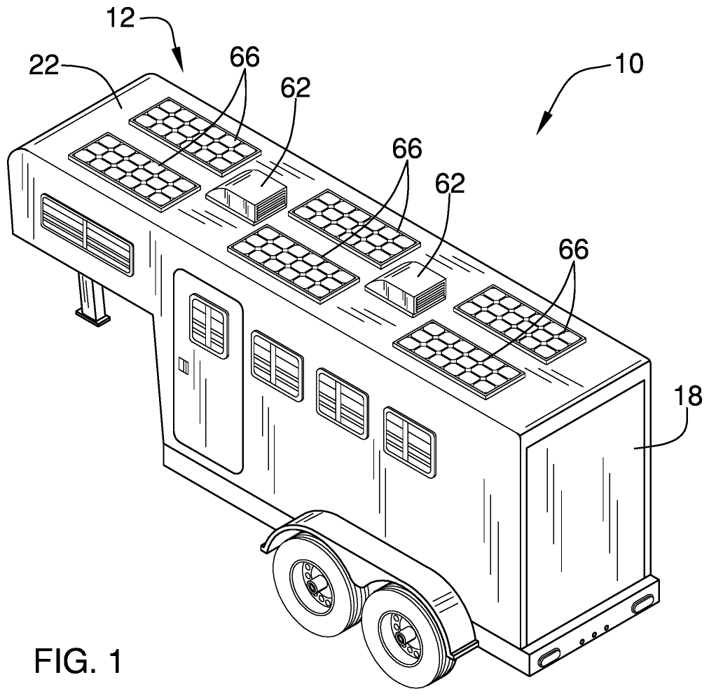

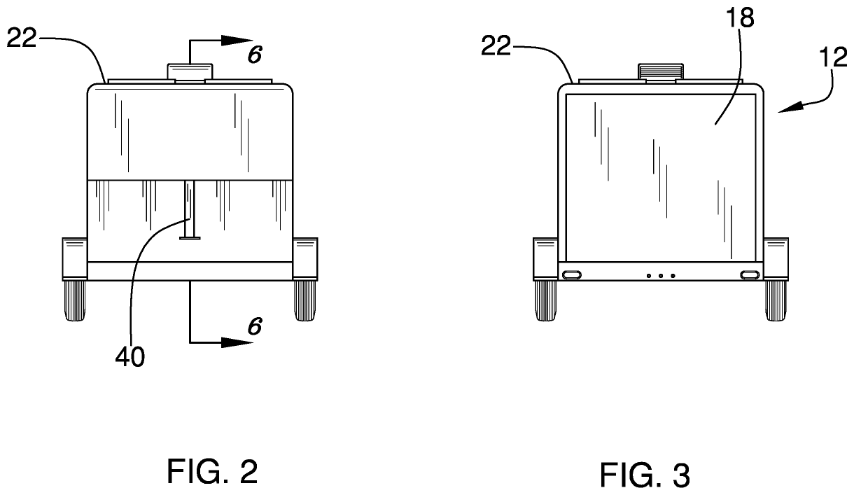

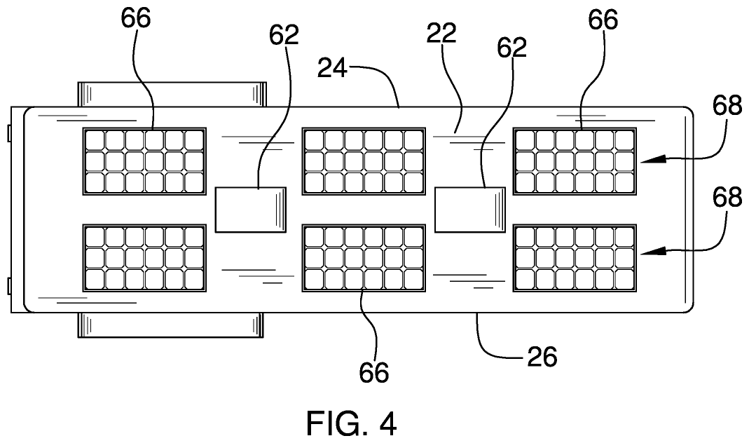

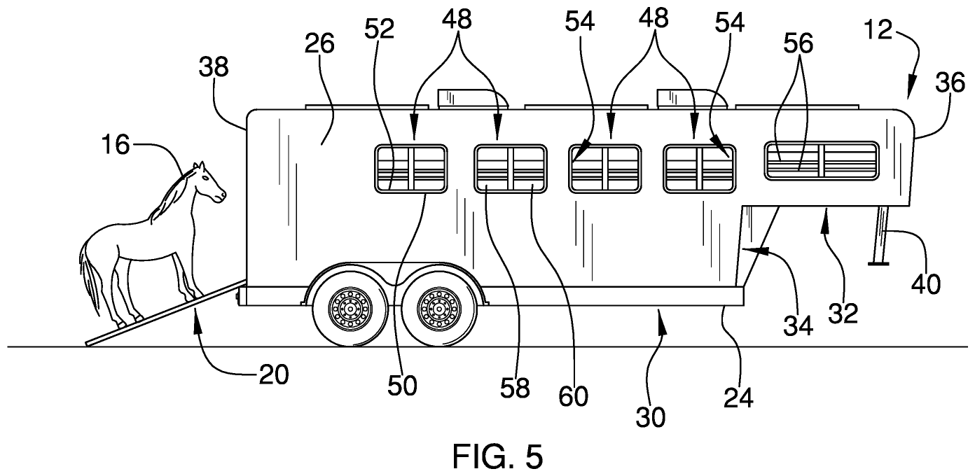

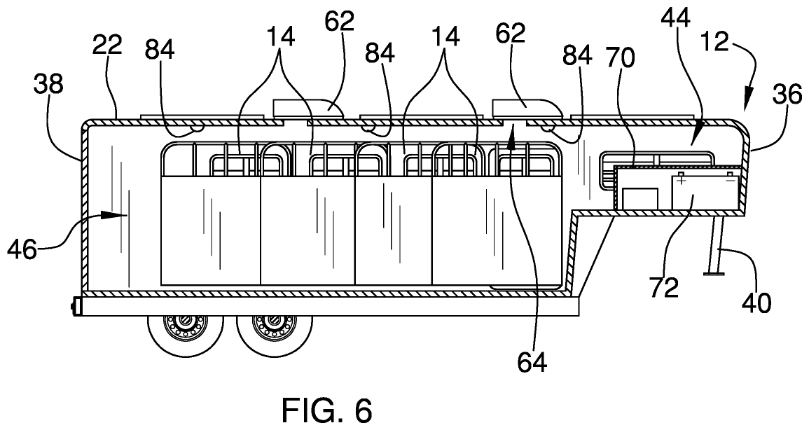

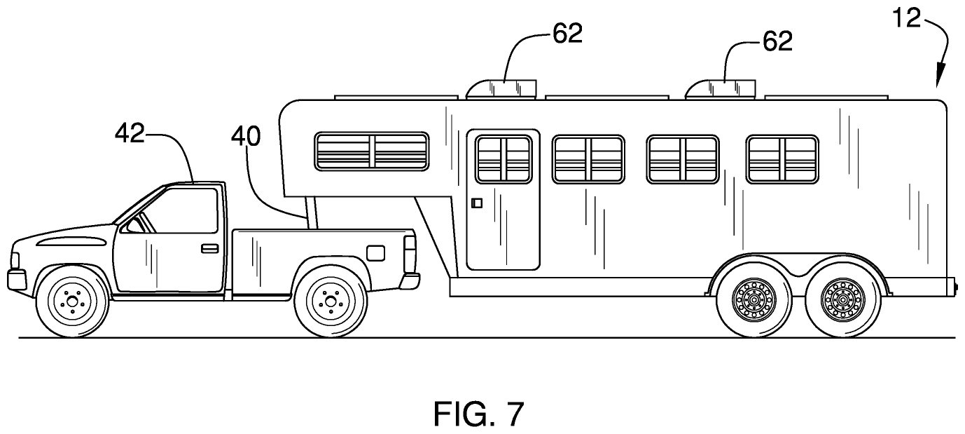

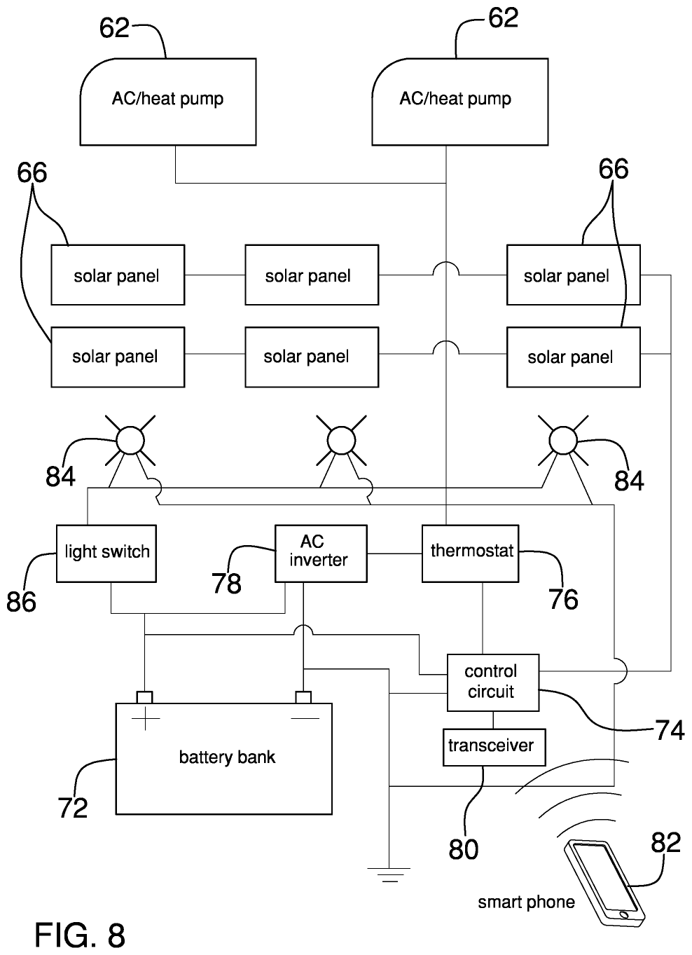

With reference now to the drawings, and in particular to FIGS. 1 through 8 thereof, a new equine trailer device embodying the principles and concepts of an embodiment of the disclosure and generally designated by the reference numeral 10 will be described.

As best illustrated in FIGS. 1 through 8, the climate controlled equine trailer device 10 generally comprises a gooseneck trailer 12 that has a plurality of horse stalls 14 being located within the gooseneck trailer 12 to transport a plurality of horses 16. The gooseneck trailer 12 has a drop-down door 18 which defines a ramp 20 when the drop-down door 18 is in an open position to facilitate the horses 16 to enter the gooseneck trailer 12. The gooseneck trailer 12 has a top wall 22, a bottom wall 24, a first lateral wall 26 and a second lateral wall 28; the bottom wall 24 has a rear portion 30, a front portion 32 and a vertical portion 34 extending between and being perpendicularly oriented with the rear portion 30 and the front portion 32 such that the front portion 32 is spaced upwardly from the rear portion 30. A front end 36 of the gooseneck trailer 12 is associated with the front portion 32 and a back end 38 of the gooseneck trailer 12 is associated with the rear portion 30.

The gooseneck trailer 12 has a hitch 40 extending downwardly from the front portion 32 of the bottom wall 24 thereby facilitating the hitch 40 to be coupled to a tow vehicle 42 for towing the gooseneck trailer 12. The front portion 32 of the bottom wall 24 defines a forward space 44 between the front portion 32 and the top wall 22 of the gooseneck trailer 12. The rear portion 30 of the bottom wall 24 defines a rear space 46 between the rear portion 30 and the top wall 22 of the gooseneck trailer 12 and each of the horse stalls 14 is positioned in the rear space 46. The gooseneck trailer 12 may be manufactured in a variety of lengths for accommodating various numbers of horses.

A plurality of windows 48 is provided and each of the plurality of windows 48 is movably integrated into a respective one of the first lateral wall 26 and the second lateral wall 28 of the gooseneck trailer 12. Each of the plurality of windows 48 has a bottom edge 50 that is hingedly coupled to a lower bounding edge 52 of a respective one of a plurality of window openings 54 in the respective first lateral wall 26 and the second lateral wall 28 of the gooseneck trailer 12. In this way each of the plurality of windows 48 can be positioned in an open position for ventilating an interior of the gooseneck trailer 12 or a closed position. Each of the plurality of windows 48 may include a series of horizontal bars 56 and each of the plurality of windows 48 may include a first section 58 that is fixed and a second section 60 that is slidable for opening the plurality of windows 48 without having to hinge the windows 48 downwardly.

A plurality of air conditioning units 62 is provided and each of the air conditioning units 62 is attached to the gooseneck trailer 12. Each of the plurality of air conditioning units 62 is in fluid communication with an interior of the gooseneck trailer 12 thereby facilitating each of the plurality of air conditioning units 62 to cool an interior of the gooseneck trailer 12. In this way each of the plurality of air conditioning units 62 can inhibit the horses 16 inside of the gooseneck trailer 12 from being exposed to dangerously high temperatures. Furthermore, each of the plurality of air conditioning units 62 may comprise a heat-pump or other type of electronic air conditioner that is commonly employed in residential or commercial heating and cooling systems. Each of the plurality of air conditioning units 62 is positioned on the top wall 22 of the gooseneck trailer 12 and each of the plurality of air conditioning units 62 has an output 64 extending through the top wall 22 thereby facilitating each of the air conditioning units 62 to blow cooled air through the top wall 22.

A plurality of solar panels 66 is provided and each of the solar panels 66 is attached to the gooseneck trailer 12 such that each of the solar panels 66 is exposed to sunlight. Each of the plurality of solar panels 66 is in electrical communication with the plurality of air conditioning units 62 for supplying electrical power to the plurality of air conditioning units 62. In this way the plurality of air conditioning units 62 is operatable independent of an external power source. Each of the plurality of solar panels 66 is positioned on the top wall 22 of the gooseneck trailer 12 and the plurality of solar panels 66 is arranged in a pair of rows 68 extending between the front end 36 and the back end 38 of the gooseneck trailer 12. Additionally, each the plurality of air conditioning units 62 is positioned between the pair of rows 68 of the solar panels 66. The pair of air conditioning units 62 is spaced apart from each other and is distributed between the front end 36 and the back end 38 of the gooseneck trailer 12.

A housing 70 is provided and the housing 70 extends upwardly from the front portion 32 of the bottom wall 24 of the gooseneck trailer 12 such that the housing 70 is positioned in the forward space 44 in the gooseneck trailer 12. A plurality of batteries 72 is provided and each of the plurality of batteries 72 is positioned within the housing 70. Additionally, each of the plurality of batteries 72 is electrically coupled to the plurality of solar panels 66 such that the plurality of solar panels 66 charges the plurality of batteries 72. Each of the plurality of batteries 72 is electrically coupled to the plurality of air conditioning units 62 for supplying electrical power to the plurality of air conditioning units 62.

A control circuit 74 is positioned within the housing 70 and the control circuit 74 is electrically coupled between the plurality of batteries 72 and the plurality of solar panels 66 for controlling charging the plurality of batteries 72. The control circuit 74 includes a thermostat 76 that is in thermal communication with an interior of the gooseneck trailer 12 and the control circuit 74 actuates the plurality of air conditioning units 62 when the thermostat 76 senses a temperature that is above a pre-determined trigger temperature. Furthermore, the control circuit 74 de-actuates the plurality of air conditioning units 62 when the thermostat 76 senses a temperature that is below a pre-determined cut-off temperature. The control circuit 74 includes an inverter 78 for converting direct current electricity from the plurality of batteries 72 into alternating current electricity that is supplied to the plurality of air conditioning units 62.

A transceiver 80 is positioned within the housing 70 and the transceiver 80 is electrically coupled to the control circuit 74. The transceiver 80 is in wireless communication with a personal electronic device 82 thereby facilitating the personal electronic device 82 to remotely control operational parameters of the plurality of air conditioning units 62. Additionally, the operational parameters includes, but is not limited to, actuating and de-actuating the plurality of air conditioning units 62 and establishing the pre-determined trigger temperature of the plurality of air conditioning units 62. The transceiver 80 may comprise a radio frequency transceiver or the like and the transceiver 80 may employ Bluetooth communication protocols. The personal electronic device 82 may comprise a smart phone or other similar type of electronic device which has wireless communication capabilities. Furthermore, the personal electronic device 82 may have data storage capabilities for storing a smart phone application which facilitates the operational parameters of the plurality of air conditioning units 62 to be remotely adjusted and controlled.

A plurality of light emitters 84 is attached to the top wall 22 of the gooseneck trailer 12 such that each of the plurality of light emitters 84 is positioned within the gooseneck trailer 12. In this way each of the plurality of light emitters 84 can emit light into an interior of the gooseneck trailer 12 when the plurality of light emitters 84 is turned on. Each of the plurality of light emitters 84 is electrically coupled to the plurality of batteries 72. Additionally, each of the plurality of light emitters 84 may comprise light emitting diode or other type of electronic light emitter and a lens. A light switch 86 is positioned within the gooseneck trailer 12 and the light switch 86 is electrically coupled to the plurality of light emitters 84 for turning the plurality of light emitters 84 on and off.

In use, the personal electronic device 82 is synchronized with the transceiver 80 to facilitate the personal electronic device 82 to adjust the operational parameters of the plurality of air conditioning units 62. In this way the interior of the gooseneck trailer 12 can be maintained at a comfortable temperature for the horses 16 while the gooseneck trailer 12 is being towed during daylight hours. Additionally, the plurality of solar panels 66 and the plurality of batteries 72 facilitates the plurality of air conditioning units 62 to be powered while the gooseneck trailer 12 is being towed. In this way the air conditioning units 62 can maintain the internal temperature of the gooseneck trailer 12 at a continuous temperature regardless of whether the gooseneck trailer 12 is being towed or if the gooseneck trailer 12 is stationary.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A climate controlled equine trailer device for cooling horses being transported thereby inhibiting the horses from being exposed to dangerously high temperatures, said device comprising:
a gooseneck trailer having a plurality of horse stalls being located within said gooseneck trailer wherein said gooseneck trailer is configured to transport a plurality of horses, said gooseneck trailer having a drop-down door which defines a ramp when said drop-down door is in an open position wherein said ramp is configured to facilitate the horses to enter said gooseneck trailer;
a plurality of air conditioning units, each of said air conditioning units being attached to said gooseneck trailer, each of said plurality of air conditioning units being in fluid communication with an interior of said gooseneck trailer thereby facilitating each of said plurality of air conditioning units to cool an interior of said gooseneck trailer wherein each of said plurality of air conditioning units is configured to inhibit the horses inside of said gooseneck trailer from being exposed to dangerously high temperatures;
a plurality of solar panels, each of said solar panels being attached to said gooseneck trailer wherein each of said solar panels is configured to be exposed to sunlight, each of said plurality of solar panels being in electrical communication with said plurality of air conditioning units for supplying electrical power to said plurality of air conditioning units wherein said plurality of air conditioning units is configured to be operatable independent of an external power source;
a plurality of light emitters, each of said plurality of light emitters being attached to said top wall of said gooseneck trailer such that each of said plurality of light emitters is positioned within said gooseneck trailer wherein each of said plurality of light emitters is configured to emit light into an interior of said gooseneck trailer; and
a light switch being positioned within said gooseneck trailer, said light switch being electrically coupled to said plurality of light emitters for turning said plurality of light emitters on and off.

2. The device according to claim 1, wherein:
said gooseneck trailer has a top wall, a bottom wall, a first lateral wall and a second lateral wall, said bottom wall having a rear portion, a front portion and a vertical portion extending between and being perpendicularly oriented with said rear portion and said front portion such that said front portion is spaced upwardly from said rear portion, a front end of said gooseneck trailer being associated with said front portion, a back end of said gooseneck trailer being associated with said rear portion;
said gooseneck trailer has a hitch extending downwardly from said front portion of said bottom wall thereby facilitating said hitch to be coupled to a tow vehicle for towing said gooseneck trailer, said front portion of said bottom wall defining a forward space between said front portion and said top wall of said gooseneck trailer, said rear portion of said bottom wall defining a rear space between said rear portion and said top wall of said gooseneck trailer; and
each of said horse stalls is positioned in said rear space.

3. The device according to claim 2, further comprising a plurality of windows, each of said plurality of windows being movably integrated into a respective one of said first lateral wall and said second lateral wall of said gooseneck trailer, each of said plurality of windows having a bottom edge being hingedly coupled to a lower bounding edge of a respective one of a plurality of window openings in said respective first lateral wall and said second lateral wall of said gooseneck trailer thereby facilitating each of said plurality of windows to be positioned in an open position for ventilating an interior of said gooseneck trailer or a closed position.

4. The device according to claim 2, wherein:
each of said plurality of air conditioning units is positioned on said top wall of said gooseneck trailer, each of said plurality of air conditioning units having an output extending through said top wall thereby facilitating each of said air conditioning units to blow cooled air through said top wall;
each of said plurality of solar panels is positioned on said top wall of said gooseneck trailer, said plurality of solar panels being arranged in a pair of rows extending between said front end and said back end of said gooseneck trailer; and
each said plurality of air conditioning units is positioned between said pair of rows of said solar panels, said pair of air conditioning units being spaced apart from each other and being distributed between said front end and said back end of said gooseneck trailer.

5. The device according to claim 2, further comprising:
a housing being extending upwardly from said front portion of said bottom wall of said gooseneck trailer such that said housing is positioned in said forward space in said gooseneck trailer; and
a plurality of batteries, each of said plurality of batteries being positioned within said housing, each of said plurality of batteries being electrically coupled to said plurality of solar panels such that said plurality of solar panels charges said plurality of batteries, each of said plurality of batteries being electrically coupled to said plurality of air conditioning units for supplying electrical power to said plurality of air conditioning units.

6. The device according to claim 5, wherein:
said device includes a control circuit being positioned within said housing, said control circuit being electrically coupled between said plurality of batteries and said plurality of solar panels for controlling charging said plurality of batteries;
said control circuit includes a thermostat being in thermal communication with an interior of said gooseneck trailer, said control circuit actuating said plurality of air conditioning units when said thermostat senses a temperature that is above a pre-determined trigger temperature, said control circuit de-actuating said plurality of air conditioning units when said thermostat senses a temperature that is below a pre-determined cut-off temperature; and
said control circuit including an inverter for converting direct current electricity from said plurality of batteries into alternating current electricity being supplied to said plurality of air conditioning units.

7. The device according to claim 6, further comprising a transceiver being positioned within said housing, said transceiver being electrically coupled to said control circuit, said transceiver being in wireless communication with a personal electronic device thereby facilitating said personal electronic device to remotely control operational parameters of said plurality of air conditioning units, said operational parameters including actuating and de-actuating said plurality of air conditioning units and establishing said pre-determined trigger temperature of said plurality of air conditioning units.

8. A climate controlled equine trailer device for cooling horses being transported thereby inhibiting the horses from being exposed to dangerously high temperatures, said device comprising:
a gooseneck trailer having a plurality of horse stalls being located within said gooseneck trailer wherein said gooseneck trailer is configured to transport a plurality of horses, said gooseneck trailer having a drop-down door which defines a ramp when said drop-down door is in an open position wherein said ramp is configured to facilitate the horses to enter said gooseneck trailer, said gooseneck trailer having a top wall, a bottom wall, a first lateral wall and a second lateral wall, said bottom wall having a rear portion, a front portion and a vertical portion extending between and being perpendicularly oriented with said rear portion and said front portion such that said front portion is spaced upwardly from said rear portion, a front end of said gooseneck trailer being associated with said front portion, a back end of said gooseneck trailer being associated with said rear portion, said gooseneck trailer having a hitch extending downwardly from said front portion of said bottom wall thereby facilitating said hitch to be coupled to a tow vehicle for towing said gooseneck trailer, said front portion of said bottom wall defining a forward space between said front portion and said top wall of said gooseneck trailer, said rear portion of said bottom wall defining a rear space between said rear portion and said top wall of said gooseneck trailer, each of said horse stalls being positioned in said rear space;
a plurality of windows, each of said plurality of windows being movably integrated into a respective one of said first lateral wall and said second lateral wall of said gooseneck trailer, each of said plurality of windows having a bottom edge being hingedly coupled to a lower bounding edge of a respective one of a plurality of window openings in said respective first lateral wall and said second lateral wall of said gooseneck trailer thereby facilitating each of said plurality of windows to be positioned in an open position for ventilating an interior of said gooseneck trailer or a closed position;
a plurality of air conditioning units, each of said air conditioning units being attached to said gooseneck trailer, each of said plurality of air conditioning units being in fluid communication with an interior of said gooseneck trailer thereby facilitating each of said plurality of air conditioning units to cool an interior of said gooseneck trailer wherein each of said plurality of air conditioning units is configured to inhibit the horses inside of said gooseneck trailer from being exposed to dangerously high temperatures, each of said plurality of air conditioning units being positioned on said top wall of said gooseneck trailer, each of said plurality of air conditioning units having an output extending through said top wall thereby facilitating each of said air conditioning units to blow cooled air through said top wall;
a plurality of solar panels, each of said solar panels being attached to said gooseneck trailer wherein each of said solar panels is configured to be exposed to sunlight, each of said plurality of solar panels being in electrical communication with said plurality of air conditioning units for supplying electrical power to said plurality of air conditioning units wherein said plurality of air conditioning units is configured to be operatable independent of an external power source, each of said plurality of solar panels being positioned on said top wall of said gooseneck trailer, said plurality of solar panels being arranged in a pair of rows extending between said front end and said back end of said gooseneck trailer, each said plurality of air conditioning units being positioned between said pair of rows of said solar panels, said pair of air conditioning units being spaced apart from each other and being distributed between said front end and said back end of said gooseneck trailer;
a housing being extending upwardly from said front portion of said bottom wall of said gooseneck trailer such that said housing is positioned in said forward space in said gooseneck trailer;
a plurality of batteries, each of said plurality of batteries being positioned within said housing, each of said plurality of batteries being electrically coupled to said plurality of solar panels such that said plurality of solar panels charges said plurality of batteries, each of said plurality of batteries being electrically coupled to said plurality of air conditioning units for supplying electrical power to said plurality of air conditioning units;
a control circuit being positioned within said housing, said control circuit being electrically coupled between said plurality of batteries and said plurality of solar panels for controlling charging said plurality of batteries, said control circuit including a thermostat being in thermal communication with an interior of said gooseneck trailer, said control circuit actuating said plurality of air conditioning units when said thermostat senses a temperature that is above a pre-determined trigger temperature, said control circuit de-actuating said plurality of air conditioning units when said thermostat senses a temperature that is below a pre-determined cut-off temperature, said control circuit including an inverter for converting direct current electricity from said plurality of batteries into alternating current electricity being supplied to said plurality of air conditioning units;
a transceiver being positioned within said housing, said transceiver being electrically coupled to said control circuit, said transceiver being in wireless communication with a personal electronic device thereby facilitating said personal electronic device to remotely control operational parameters of said plurality of air conditioning units, said operational parameters including actuating and de-actuating said plurality of air conditioning units and establishing said pre-determined trigger temperature of said plurality of air conditioning units;
a plurality of light emitters, each of said plurality of light emitters being attached to said top wall of said gooseneck trailer such that each of said plurality of light emitters is positioned within said gooseneck trailer wherein each of said plurality of light emitters is configured to emit light into an interior of said gooseneck trailer, each of said plurality of light emitters being electrically coupled to said plurality of batteries; and
a light switch being positioned within said gooseneck trailer, said light switch being electrically coupled to said plurality of light emitters for turning said plurality of light emitters on and off.
